(19) United States
(12) Patent Application Publication
(10) Pub. No.: US 2012/0268474 A1
(43) Pub. Date: Oct. 25, 2012

(54) INFORMATION PROCESSOR, INFORMATION PROCESSING METHOD, AND COMPUTER PROGRAM PRODUCT

(76) Inventor: Koji Hachiya, Tokyo (JP)

(21) Appl. No.: 13/329,042

(22) Filed: Dec. 16, 2011

(30) Foreign Application Priority Data
Apr. 19, 2011 (JP) 2011-093442

(51) Int. Cl. G09G 5/00

(52) U.S. Cl. 345/581

(57) ABSTRACT

According to one embodiment, an information processor includes a moving image reproducing module, a display module, and an image quality adjusting module. The moving image reproducing module reproduces moving image content. The display module displays a screen of the moving image content reproduced by the moving image reproducing module. The image quality adjusting module adjusts the image quality of the screen, which is displayed by the display module, depending on whether the moving image reproducing module is reproducing the moving image content.

### CROSS-REFERENCE TO RELATED APPLICATIONS

This application is based upon and claims the benefit of priority from Japanese Patent Application No. 2011-093442, filed Apr. 19, 2011, the entire contents of which are incorporated herein by reference.

### FIELD

Embodiments described herein relate generally to an information processor, an information processing method, and a computer program product.

### BACKGROUND

Generally, display signals are subjected to gamma conversion by referring to a look-up table for gamma correction (gamma table) to adjust the image quality of a display screen. There has been disclosed a technology that makes the gamma conversion characteristics variable depending on the contents of the display signals that are fed to a display device or depending on the environment in which the display device is installed.

Meanwhile, consider the case of reproducing moving image content in a personal computer (PC) or the like. To reproduce the moving image content, the image quality of the screen is sometimes adjusted by, for example, setting a higher lightness as compared to the case of displaying a basic operation screen such as a desktop screen. In this case, if the basic operation screen is displayed referring to a gamma table for reproducing the moving images, the graphical user interface (GUI) configured with colors close to each other suffers from a decrease in the color difference. Such a condition may cause difficulty in viewing the screen. In regard to this, there is a demand for such a technology that enables automatic changeover in the image quality of displayed screens depending on the reproduction status of moving image content. In the conventional technology, since the reproduction status of moving image content is not taken into consideration, it is difficult to change the image quality depending on whether the moving image content is being reproduced.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary external perspective view of a notebook personal computer (PC) according to an embodiment;

FIG. 2 is an exemplary diagram of a hardware configuration of the notebook PC in the embodiment;

FIG. 3 is an exemplary graph of a brightness conversion table illustrated in FIG. 2 in the embodiment;

FIG. 4 is an exemplary graph of a moving-image-reproduction gamma table and a normal use gamma table illustrated in FIG. 2 in the embodiment;

FIG. 5 is an exemplary diagram of a functional configuration of the notebook PC in the embodiment;

FIG. 6 is an exemplary diagram of a video player in the embodiment;

FIG. 7 is an exemplary diagram for explaining the functions of an image quality adjusting module illustrated in FIG. 5 in the embodiment;

FIG. 8 is an exemplary flowchart of a brightness change process in the embodiment;

FIG. 9 is an exemplary flowchart of a status management process in the embodiment;

FIG. 10 is an exemplary flowchart of a gamma change process in the embodiment; and

FIG. 11 is an exemplary flowchart of a display output process in the embodiment.

### DETAILED DESCRIPTION

In general, according to one embodiment, an information processor comprises a moving image reproducing module, a display module, and an image quality adjusting module. The moving image reproducing module is configured to reproduce moving image content. The display module is configured to display a screen of the moving image content reproduced by the moving image reproducing module. The image quality adjusting module is configured to adjust the image quality of the screen, which is displayed by the display module, depending on whether the moving image reproducing module is reproducing the moving image content.

Exemplary embodiments will be described in detail below with reference to the accompanying drawings. In the following embodiments, the information processor will be described by way of example as being applied to a notebook personal computer (PC). However, the embodiments may also be applicable to any other information processor such as desktop computers, smartphones, tablet computers, and the like.

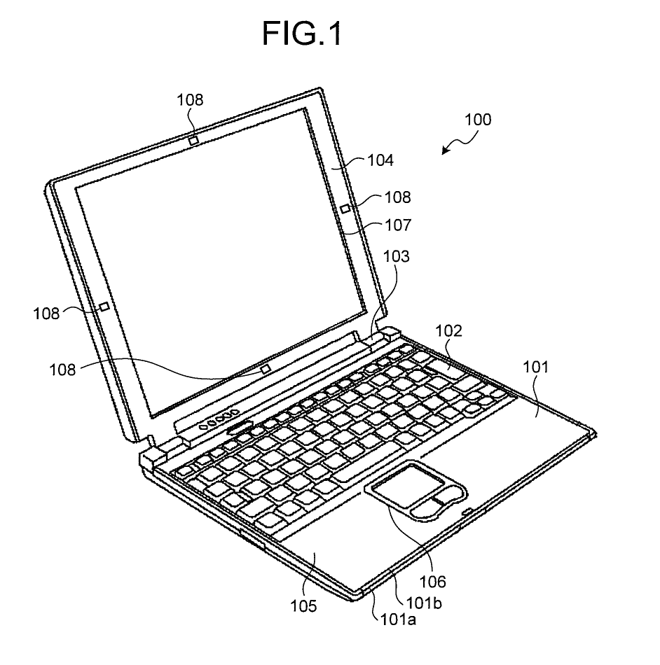

FIG. 1 is an external perspective view of a notebook PC 100 according to the embodiment. As illustrated in FIG. 1, the notebook PC 100 comprises a housing 101, a keyboard 102 that is installed on the housing 101, and a panel-side housing 104 that is connected to the housing 101 in a rotatable manner via a hinge 103.

The housing 101 comprises a lower casing 101a and an upper casing 101b. At the front end of the top surface of the upper casing 101b is configured a palm rest 105. Roughly in the center of the palm rest 105 is installed a touch-pad 106. In the central portion of the panel-side housing 104 is installed a display module 107, which is a flat panel display such as a liquid crystal display (LCD). At the center of each of the four sides of the panel-side housing 104 is disposed an illuminance sensor 108. The positions and the number of the illuminance sensors 108 are not limited as illustrated in FIG. 1.

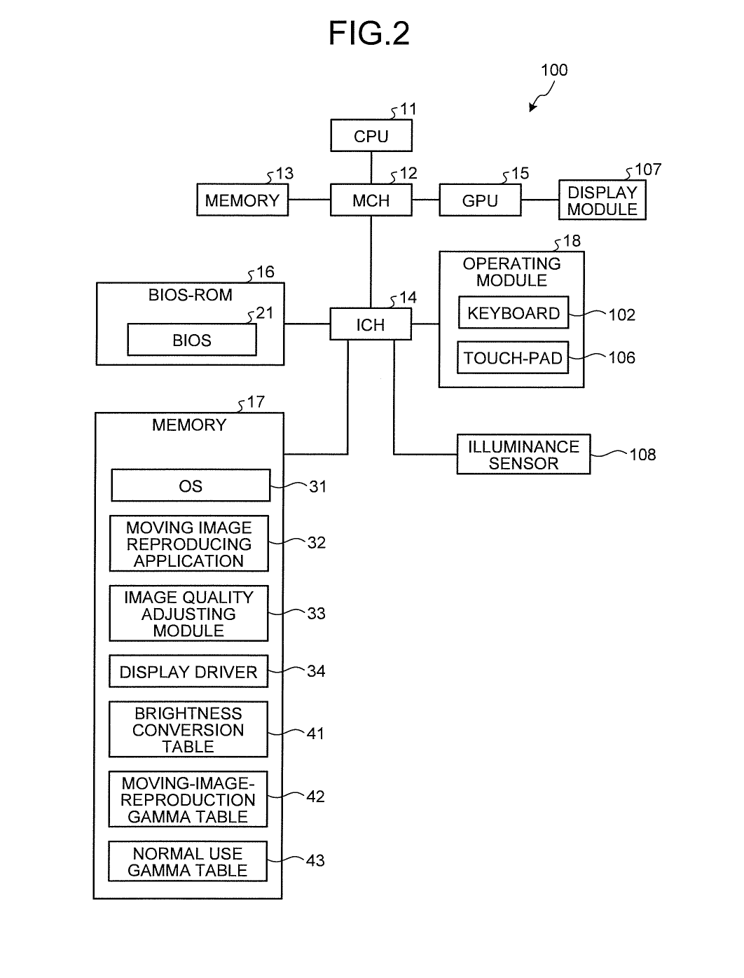

FIG. 2 is a diagram of a hardware configuration of the notebook PC 100. As illustrated in FIG. 2, the notebook PC 100 comprises a central processing unit (CPU) 11, a memory controller hub (MCH) 12, a memory 13, an I/O controller hub (ICH) 14, a graphics processing unit (GPU) 15, a BIOS-ROM 16 (where BIOS stands for basic input/output system, ROM stands for read only memory), a memory 17, the display module 107, an operating module 18, and the illuminance sensors 108.

The CPU 11 is a processor configured to implement various functions by executing various programs stored in the BIOS-ROM 16 and the memory 17. With this, the CPU 11 controls the operations of the notebook PC 100 in a comprehensive manner.

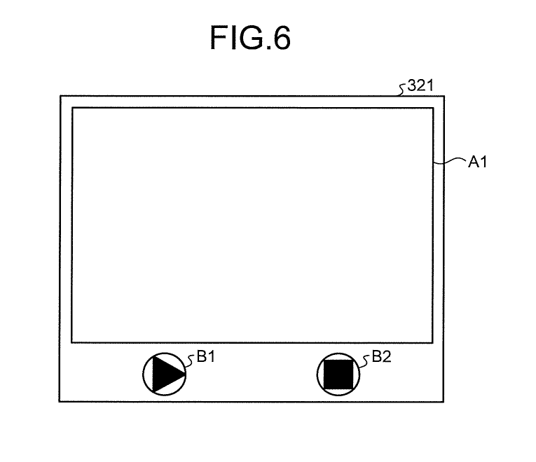

More particularly, the CPU 11 executes a BIOS 21, which is stored in the BIOS-ROM 16, so as to implement the function of controlling various hardware components. Moreover, the CPU 11 executes an operating system (OS) 31, which is loaded in the memory 13 from the memory 17, so as to implement the functions of an operating system. Furthermore, the CPU 11 executes a moving image reproducing application 32, which is loaded in the memory 13 from the memory 17, so as to implement (run) a video player (described later with reference to FIG. 6) that has the function of reproducing moving image content. Besides, the CPU 11 executes an image quality adjusting module 33, which is loaded in the memory 13 from the memory 17, so as to implement the function of adjusting the image quality of display signals. In addition, the CPU 11 executes a display driver 34, which is loaded in the memory 13 from the memory 17, so as to implement the function of controlling the operations of the GPU 15.

The MCH 12 is a bridge device configured to connect the local bus of the CPU 11 with the ICH 14. In the MCH 12 comprises a built-in memory controller configured to perform access control with respect to the memory 13. Moreover, the MCH 12 has the function of communicating with the GPU 15 via an accelerated graphics port (AGP) bus or a serial bus of PCI express standard.

The memory 13 is the main memory device of the notebook PC 100 and functions as the work area for the CPU 11 and for the GPU 15. The ICH 14 is configured to control each such device that is connected to a low pin count (LPC) bus or a peripheral component interconnect (PCI) bus. Besides, the ICH 14 comprises a built-in controller configured to control the memory 17.

The GPU 15 follows instructions from the CPU 11 and performs predetermined image processing on display signals, and then delivers the processed display signals to the display module 107. Herein, to the display module 107, the GPU 15 sends a basic operation screen that serves as the GUI to enable operations of the notebook PC 100 and sends a screen of moving image content reproduced by a video player 321 (described later). Thus, on the display module 107 are displayed the basic operation screen and the screen of moving image content.

The BIOS-ROM 16 is a nonvolatile storage medium that stores the BIOS 21, which is a computer program for hardware control.

The memory 17 is a nonvolatile storage medium such as a hard disk drive (HDD) or a solid state drive (SSD) that stores various computer programs such as the OS 31, the moving image reproducing application 32, the image quality adjusting module 33, and the display driver 34 that are executed by the CPU 11. The function of each of those computer programs is described later.

Moreover, as the setting information related to the semantics of various computer programs, the memory 17 stores a brightness conversion table 41, a moving-image-reproduction gamma table 42, and a normal use gamma table 43. The brightness conversion table 41 defines brightness values corresponding to illuminance values.

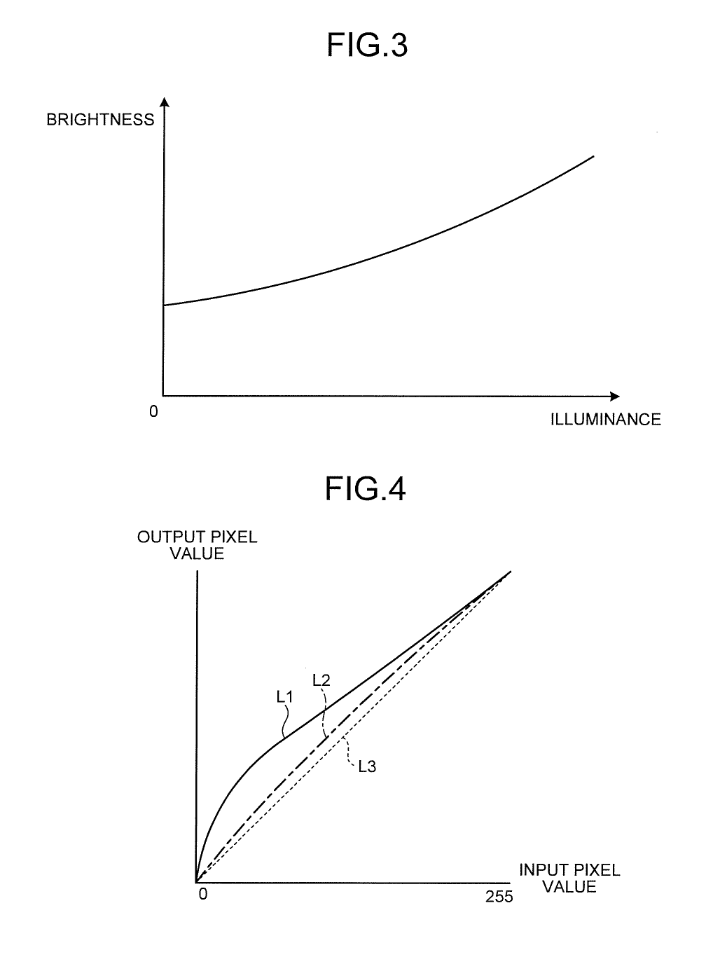

FIG. 3 is a graph schematically illustrating an example of the brightness conversion table 41. In FIG. 3, the horizontal axis represents the illuminance value and the vertical axis represents the brightness value. In the brightness conversion table 41, corresponding to each illuminance value is fixed a brightness value. Thus, by referring to the illuminance values, the respective brightness values can be uniquely identified. Moreover, in the brightness conversion table 41 illustrated in FIG. 3, the brightness conversion table 41 is so created that the greater the illuminance value, the greater the corresponding brightness value.

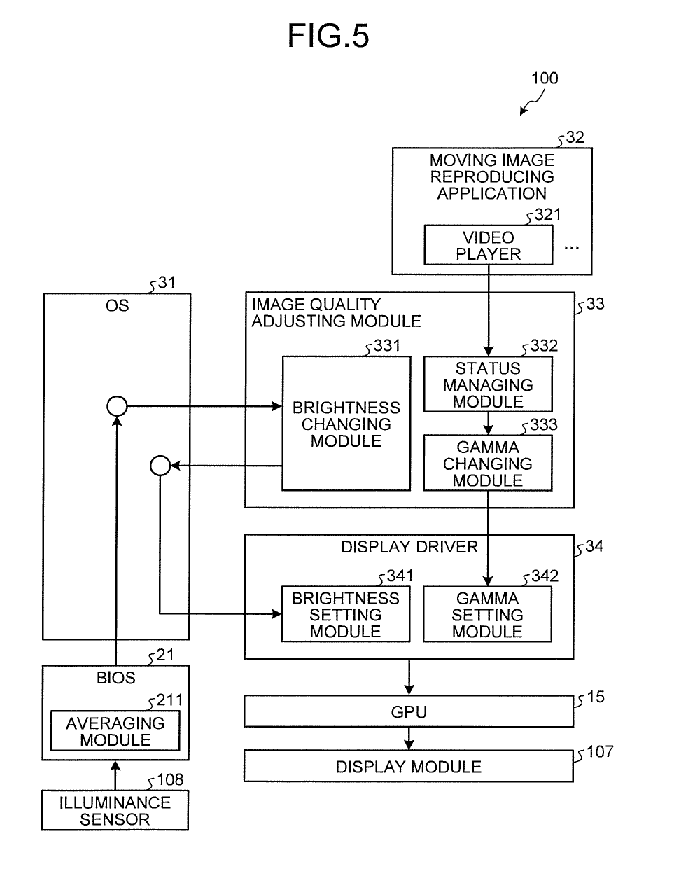

FIG. 4 is a graph schematically illustrating an example of the moving-image-reproduction gamma table 42 and the normal use gamma table 43. In FIG. 4, the horizontal axis represents the pre-conversion pixel value (input pixel value) and the vertical axis represents the post-conversion pixel value (output pixel value). Herein, a line L1 represents the moving-image-reproduction gamma table 42 and a line L2 represents the normal use gamma table 43. Besides, a line L3 represents a gamma table that is created when gamma correction is not performed (γ=1). Meanwhile, with reference to FIG. 4, the pixel values lie in the range of 0 to 255.

The moving-image-reproduction gamma table 42 is a gamma table set for the purpose of reproducing (viewing) the moving image content. In the moving-image-reproduction gamma table 42, the post-conversion pixel values are higher as compared to the pre-conversion pixel values. Particularly, in order to increase the degree of lightness of dark sections among the display signals (i.e., dark sections within images), the lower pixel values in the moving-image-reproduction gamma table 42 are set to have a higher rate of increase. Meanwhile, the normal use gamma table 43 is set for the normal use, such as the case of displaying the basic operation screen, other than the case of reproducing moving image content. In the normal use gamma table 43, the rate of increase between the pre-conversion pixel values and the post-conversion pixel values is kept low as compared to the moving-image-reproduction gamma table 42.

The moving-image-reproduction gamma table 42 and the normal use gamma table 43 are not limited to only one type of gamma tables. Alternatively, for example, for each brightness value in the brightness conversion table 41, the moving-image-reproduction gamma table 42 and the normal use gamma table 43 can be created in a corresponding manner depending on that brightness value. Moreover, in the embodiment, although the moving-image-reproduction gamma table 42 and the normal use gamma table 43 are created independently, it is also possible to replace the moving-image-reproduction gamma table 42 with such correction information that is used for correcting the normal use gamma table 43 into the moving-image-reproduction gamma table 42.

The moving-image-reproduction gamma table 42 is customized to view moving image content. Hence, if the moving-image-reproduction gamma table 42 is used to perform gamma conversion of display signals in the normal use other than the case of viewing moving image content, as compared to the case where gamma conversion is performed referring to the normal use gamma table 43, the display signals having a higher degree of lightness are displayed on the display module 107. As a result, a GUI configured with colors close to each other suffers from a decrease in the color difference. Such a condition may cause difficulty in viewing the screen. On the other hand, if the normal use gamma table 43 is used to perform gamma conversion of display signals for viewing the moving image content, as compared to the case where gamma conversion is performed referring to the moving-image-reproduction gamma table 42, the display signals having a lower degree of lightness are displayed on the display module 107. As a result, the dark sections in the images become less distinguishable, which causes difficulty in viewing.

In regard to this, in the notebook PC 100 according to the embodiment, the CPU 11 and the image quality adjusting module 33 operate in tandem to implement a status managing module 332 and a gamma changing module 333 (described later with reference to FIG. 5) that control switching of gamma tables to ensure that the moving-image-reproduction gamma table 42 is referred to at the time of reproducing (viewing) the moving image content and ensure that the normal use gamma table 43 is referred to for the normal use other than the case of reproducing moving image content.

Returning to the explanation with reference to FIG. 2, under the control of the GPU 15, the display module 107 displays the display signals sent by the GPU 15. As a result, in the display region of the display module 107 is displayed the desktop screen or the screen for reproducing the moving image content.

The operating module 18 comprises the keyboard 102 and the touch-pad 106, and receives input of operations from the operator (user) and outputs operation signals indicating the operation details to the CPU 11.

The illuminance sensors 108 are configured with phototransistors or photodiodes, and detect the illuminance values of the environment light around the notebook PC 100 and output the illuminance values to the CPU 11.

Explained below with reference to FIG. 5 is a functional configuration of the notebook PC 100. FIG. 5 is a diagram of a functional configuration of the notebook PC 100. As illustrated in FIG. 5, the functional configuration of the notebook PC 100 gets implemented when the CPU 11 executes the BIOS 21, the OS 31, the moving image reproducing application 32, the image quality adjusting module 33, and the display driver 34.

The BIOS 21 follows instructions of a software program such as the OS 31 and, along with the CPU 11, controls the hardware components. Besides, along with the CPU 11, the BIOS 21 implements an averaging module 211 that performs averaging the illuminance values detected by the illuminance sensors 108 and outputs the average illuminance value to the OS 31. Meanwhile, if only one illuminance sensor 108 is mounted, the averaging module 211 can be omitted.

The OS 31 executes, along with the CPU 11, software programs (such as the display driver 34, the moving image reproducing application 32, and the image quality adjusting module 33) as well as provides hardware resources to the executed software programs.

More particularly, the OS 31 monitors the illuminance values input from the BIOS 21 and, if an illuminance value is found to have changed to be equal to or greater than a predetermined threshold value, notifies the image quality adjusting module 33 of the illuminance value through an illuminance value change event. Besides, when a brightness changing module 331 of the image quality adjusting module 33 outputs a brightness value, the OS 31 notifies the display driver 34 (a brightness setting module 341) of the illuminance value. Meanwhile, the threshold value set for detecting a change in an illuminance value is not fixed and can be set to an arbitrary value.

The moving image reproducing application 32 is written to provide the video player 321 that has the function of reproducing moving image content. Depending on the operation signals received from the operating module 18, the CPU 11 executes the moving image reproducing application 32 so that one or more of the video players 321 are started process by process. Herein, the OS 31 manages the processes of the video players 321 that are running and the GPU 15 displays the user interface (UI) of each video player 321 on the display module 107.

The video player 321 has an UI that enables the user to play or stop the moving image content. Depending on the operation details input via the operating module 18, the video player 321 reads and reproduces the moving image content to be reproduced. Herein, the destination from which the moving image content is read can be the memory 17 or an external device connected via a network (not illustrated). Meanwhile, the moving image reproducing application 32 can be written as an independent application or as a group of a plurality of mutually different applications.

FIG. 6 is a diagram of the video player 321. As illustrated in FIG. 6, the video player 321 has a play button B1 for instructing the video player 321 to reproduce the moving image content and has a stop button for instructing the video player 321 to stop reproducing the moving image content. When the play button B1 is pressed, the video player 321 starts reproducing the moving image content, notifies the image quality adjusting module 33 of a moving-image-reproduction start event, and displays the moving image content being reproduced in an area A1. When the stop button B2 is pressed, the video player 321 stops reproducing the moving image content and notifies the image quality adjusting module 33 of a moving-image-reproduction stop event.

Meanwhile, the manner of displaying the video player 321 is not fixed. For example, the video player 321 can be displayed as a window within the basic operation screen displayed on the display module 107 or the content in the area A1 can be displayed in full-screen over the entire basic operation screen.

Returning to the explanation with reference to FIG. 5, along with the CPU 11, the image quality adjusting module 33 implements the brightness changing module 331, the status managing module 332, and the gamma changing module 333.

The brightness changing module 331 changes the illuminance value of the displayed image depending on the brightness of the environment light around the notebook PC 100. More particularly, upon receiving the notification of an illuminance value change event from the OS 31, the brightness changing module 331 refers to the brightness conversion table 41 and identifies a brightness value which corresponds to the illuminance value specified in the illuminance value change event. Then, via the OS 31, the brightness changing module 331 notifies the display driver 34 (the brightness setting module 341 described later) of the identified brightness value. In the embodiment, the brightness value identified by the brightness changing module 331 is sent to the brightness setting module 341 via the OS 31. Alternatively, the configuration can be such that the brightness changing module 331 directly notifies the brightness setting module 341 of the identified brightness value.

The status managing module 332 manages the operating status of the video player 321 that is running. More particularly, based on the events (moving-image-reproduction start event/moving-image-reproduction stop event) notified from each video player 321 that is running, the status managing module 332 manages the operating status of the video player 321 by referring to flag information provided for the video player 321. The flag information is generated for each video player 321 that is running. The flag information is set to “1” if the video player 321 is reproducing moving image content and set to “0” if the video player 321 has stopped reproducing moving image content.

Based on the statuses of the flag information managed by the status managing module 332, i.e., based on the operating statuses of all of the video players 321, the gamma changing module 333 controls switching between the gamma tables used in gamma conversion. More particularly, during the period when the flag information for at least one video player 321 is set to “1” thereby indicating that the moving image content is being reproduced, the gamma changing module 333 informs the display driver 34 to refer to the moving-image-reproduction gamma table 42. On the other hand, when the flat information for all video players 321 is set to “0” thereby indicating that the reproduction of moving image content is stopped, the gamma changing module 333 informs the display driver 34 to refer to the normal use gamma table 43.

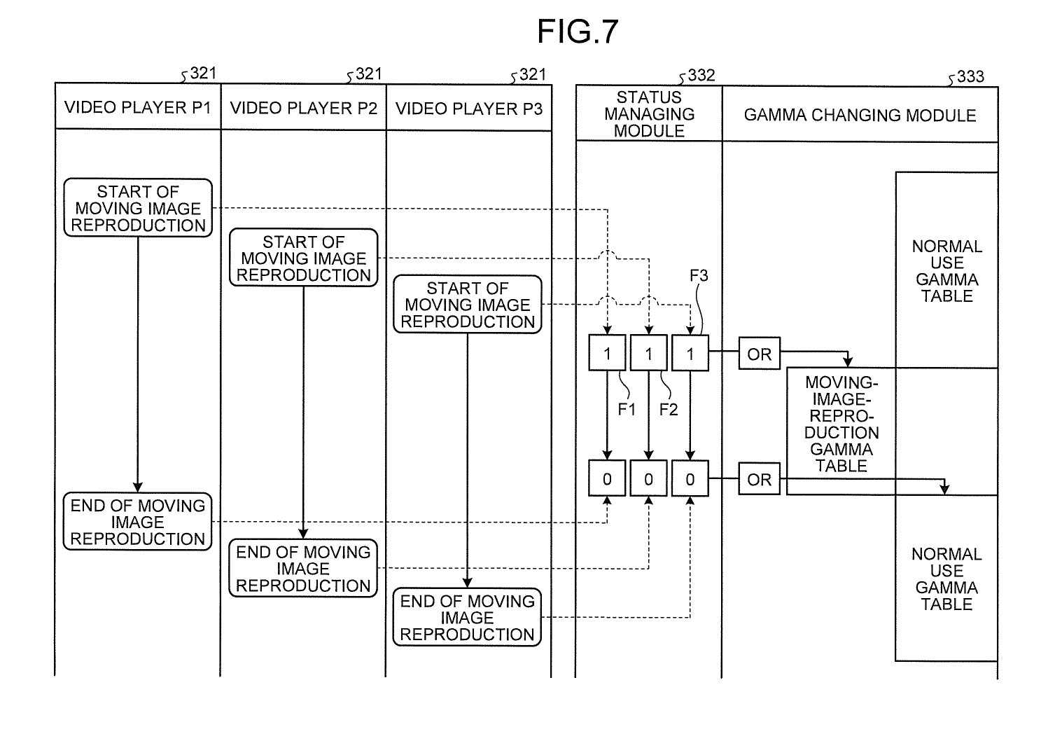

Explained below with reference to FIG. 7 are the operations performed by the status managing module 332 and the gamma changing module 333. FIG. 7 is a diagram for explaining the functions of the status managing module 332 and the gamma changing module 333. In FIG. 7, three video players 321 (video players P1 to P3) are running and the status managing module 332 manages flag information F1 to F3 corresponding to the video players P1 to P3, respectively. In the initial status of each of the video players P1 to P3, moving image content is not displayed and the corresponding flag information is set to “0”.

In FIG. 7, when any of the video players P1 to P3 starts reproducing the moving image content, the video player independently notifies the image quality adjusting module 33 (the status managing module 332) of a moving-image-reproduction start event. Upon receiving a moving-image-reproduction start event from any of the video players P1 to P3, the status managing module 332 sets the flag information corresponding to the video player to “1”. When any of the flag information F1 to F3 is updated, the gamma changing module 333 calculates the logical sum (OR) of the values set in the flag information. If the logical sum is “1”, i.e., if one or more of the video players P1 to P3 are reproducing moving image content, then the gamma changing module 333 informs the display driver 34 to refer to the moving-image-reproduction gamma table 42.

Similarly, when any of the video players P1 to P3 stops reproducing the moving image content, the video player independently notifies the image quality adjusting module 33 (the status managing module 332) of a moving-image-reproduction stop event. Upon receiving a moving-image-reproduction stop event from any of the video players P1 to P3, the status managing module 332 sets the flag information corresponding to the video player to “0”. When any of the flag information F1 to F3 is updated, the gamma changing module 333 calculates the logical sum (OR) of the values set in the flag information. If the logical sum is “0”, i.e., if all of the video players P1 to P3 have stopped reproducing moving image content, the gamma changing module 333 informs the display driver 34 to refer to the normal use gamma table 43.

Meanwhile, the status managing module 332 also has a process monitoring function for monitoring the status (existence status) of the processes being executed in the notebook PC 100 (in the OS 31). That is, when a new video player 321 is started, the status managing module 332 detects the running of the video player 321 from the process thereof. Moreover, if the process of a particular video player 321 does not exist or is not responding, then the status managing module 332 deletes the flag information corresponding to the video player 321. As a result, regarding a video player 321 that is terminated according to a predetermined procedure or that is forcibly terminated while reproducing the content, the corresponding flag information can be excluded from the information to be managed, i.e., excluded from the calculation of the logical sum performed by the gamma changing module 333.

Returning to the explanation with reference to FIG. 5, along with the CPU 11, the display driver 34 implements the brightness setting module 341 and a gamma setting module 342.

The brightness setting module 341 receives a notification of the brightness values from the OS 31 and instructs the GPU 15 to change the brightness values to the notified brightness values. The gamma setting module 342 instructs the GPU 15 to change the gamma table, which is to be used in gamma conversion, to the gamma table notified by the gamma changing module 333 (i.e., to the moving-image-reproduction gamma table 42 or the normal use gamma table 43).

The GPU 15 receives, from the brightness setting module 341, an instruction for changing the brightness values and generates display signals with the instructed brightness values. Moreover, the GPU 15 receives, from the gamma setting module 342, an instruction for changing the gamma table and then performs gamma conversion on the newly-generated display signals by referring the instructed gamma table. Then, the GPU 15 sends the post-gamma-conversion display signals to the display module 107.

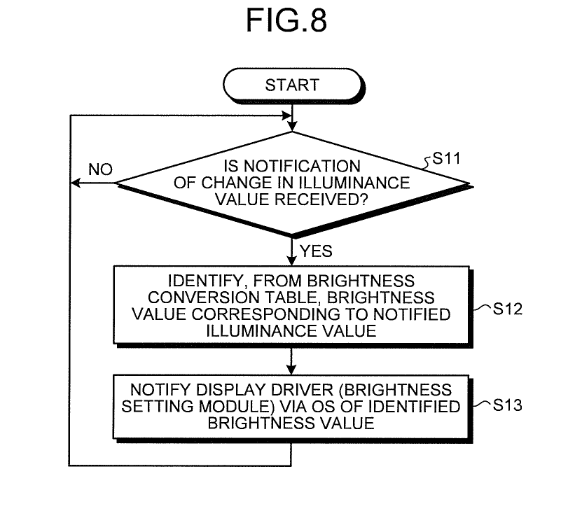

Explained below with reference to FIGS. 8 to 11 are the operations performed in the notebook PC 100 according to the embodiment. First, explained below with reference to FIG. 8 is a brightness change process performed by the brightness changing module 331 of the image quality adjusting module 33.

FIG. 8 is a flowchart of the brightness change process performed by the brightness changing module 331. First, the brightness changing module 331 waits for the notification of an illuminance value change event (No at S11). During the waiting period, the OS 31 keeps monitoring the illuminance values input via the BIOS 21 and, if an illuminance value is found to have changed to be equal to or greater than a predetermined threshold value, notifies the image quality adjusting module 33 of the illuminance value through an illuminance value change event.

Upon receiving the notification of an illuminance value change event (Yes at S11), the brightness changing module 331 refers to the brightness conversion table 41 and identifies a brightness value which corresponds to the illuminance value specified in the illuminance value change event (S12).

The brightness changing module 331 notifies, via the OS 31, the brightness setting module 341 of the display driver 34 of the brightness value identified at S12 (S13). Then, the system control returns to S11.

In this way, by performing the brightness change process, every time the illuminance of the environment light around the notebook PC 100 changes by an amount equal to or greater than a predetermined threshold value, the brightness changing module 331 instructs, via the OS 31, the brightness setting module 341 of the display driver 34 to switch the brightness value to a value corresponding to the illuminance. This enables the GPU 15 to generate display signals having brightness suitable for the environment light.

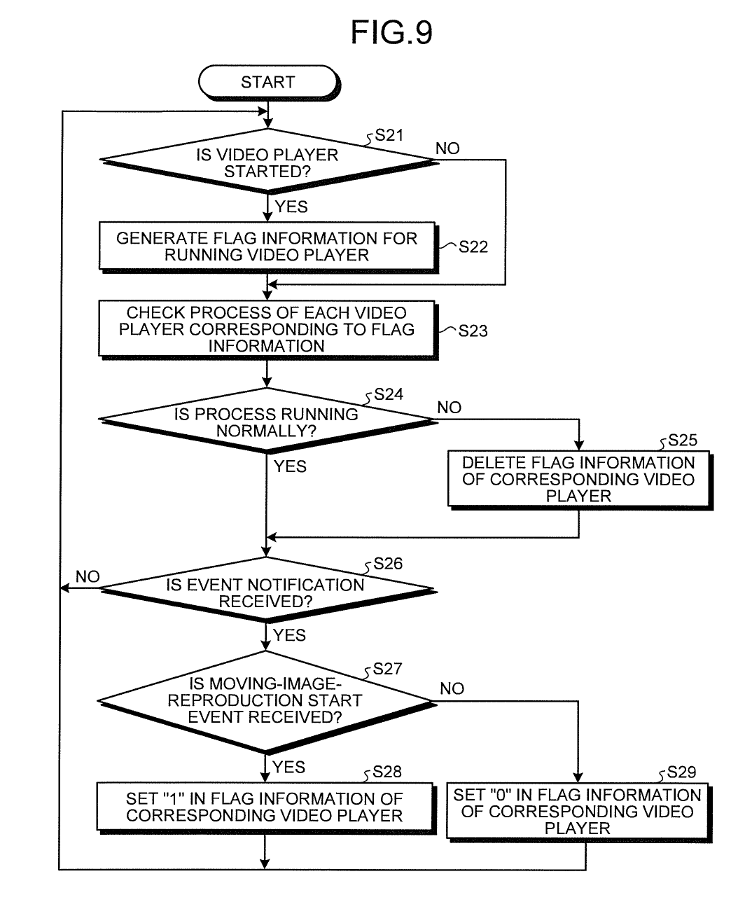

Explained below with reference to FIG. 9 is a status management process performed by the status managing module 332 in the image quality adjusting module 33. FIG. 9 is a flowchart of the status management process performed by the status managing module 332.

First, based on the status of the processes managed by the OS 31, the status managing module 332 determines whether any video player 321 is newly running (S21). If no video player 321 is newly running (No at S21), the system control proceeds to S23.

On the other hand, if the video player 321 is found to be newly running (Yes at S21), the status managing module 332 generates, in the memory 13, flag information for the video player 321 (S22) and the system control proceeds to S23. Meanwhile, the newly-generated flag information is set to “0”.

Subsequently, the status managing module 332 checks the existence of the process of each video player 321 having the corresponding flag information (S23) and determines whether the processes are running normally (S24). If the process of a particular video player 321 does not exist or is not responding (No at S24), then the status managing module 332 deletes the flag information generated for the video player 321 (S25) and the system control proceeds to S26. On the other hand, regarding the video players 321 confirmed to have a normally running process at S24, the system control proceeds to S26 with the respective flag information values kept intact.

Then, the status managing module determines whether an event is received from any of the video players 321 (S26). If no event is found (No at S26), then the system control returns to S21. On the other hand, if an event is received from any of the video players 321 (Yes at S26) and if the event is a moving-image-reproduction start event (Yes at S27), then the status managing module 332 sets “1” in the flag information of the video player 321 (S28), and the system control returns to S21.

In contrast, if an event is received from any of the video players 321 (Yes at S26) but if the event is a moving-image-reproduction stop event (No at S27), then the status managing module 332 sets “0” in the flag information of the video player 321 (S29), and the system control returns to S21.

In this way, by performing the status management process, the status managing module 332 individually manages the operating status of each running video player 321 by referring to the corresponding flag information. Thus, in the embodiment, the flag information for each video player 321 is generated or deleted depending on whether the video player 321 is running or terminated (normally or forcibly). However, alternatively, if the number of the video players 321 that can be started is fixed, then the flag information for this number of the video players 321 can be maintained from start. In such a case, when a video player 321 is terminated, the corresponding flag information can be set to

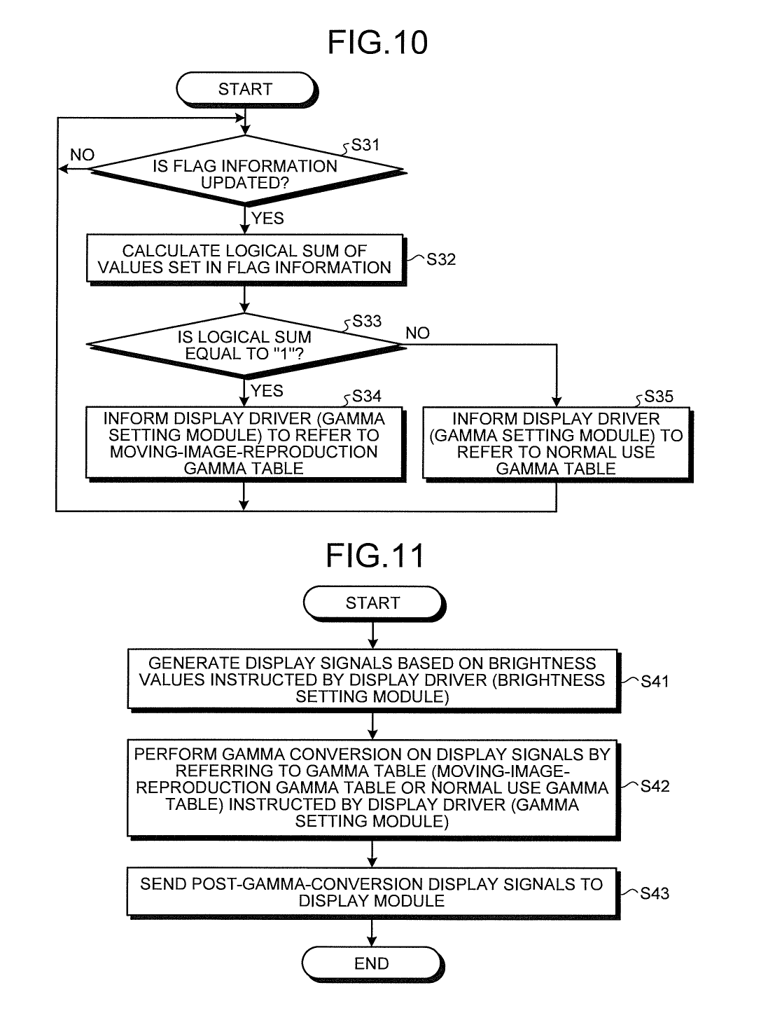

Explained below with reference to FIG. 10 is a gamma change process performed by the gamma changing module 333 of the image quality adjusting module 33. FIG. 10 is a flowchart of the gamma change process performed by the gamma changing module 333.

First, the gamma changing module 333 refers to the flag information managed by the status managing module 332 and waits until the flag information is updated (No at S31). During the waiting period, the status managing module 332 performs the status management process and updates the flag information depending on whether any video player 321 is newly started or terminated or depending on whether any video player has started reproducing the moving image content or has stopped reproducing the moving image content.

When the flag information is found to have been updated due to the generation or deletion of the flag information or due to the updating of setting values by the status managing module 332 (Yes at S31), the gamma changing module 333 calculates the logical sum of the values set in the flag information (S32) and determines whether the logical sum is “1” (S33).

If the logical sum is determined to be “1” (Yes at S33), the gamma changing module 333 informs the display driver 34 to refer to the moving-image-reproduction gamma table 42 (S34) and the system control returns to S31. On the other hand, if the logical sum is determined to be “0” (No at S33), then the gamma changing module 333 informs the display driver 34 to refer to the normal use gamma table 43 (S35) and the system control returns to S31.

In this way, by performing the gamma change process, every time the flag information is updated by the status managing module 332, the gamma changing module 333 derives the operating status of the video players from the logical sum of the updated flag information and accordingly switches to the gamma table to be used in gamma conversion.

Explained below with reference to FIG. 11 is a display output process performed by the GPU 15. FIG. 11 is a flowchart of the display output process performed by the GPU 15.

First, the GPU 15 generates display signals based on the brightness values instructed by the brightness setting module 341 of the display driver 34 (S41). Then, the GPU 15 performs gamma conversion on the display signals by referring to the gamma table (the moving-image-reproduction gamma table 42 or the normal use gamma table 43) instructed by the gamma setting module 342 of the display driver 34 (S42). Subsequently, the GPU 15 sends the post-gamma-conversion display signals to the display module 107 for display (S43).

Thus, in the display output process, the GPU 15 generates display signals based on brightness values and the gamma table instructed by the display driver 34, and sends the display signals to the display module 107. With this, when moving image content is being reproduced, a screen subjected to gamma conversion using the moving-image-reproduction gamma table 42 is displayed on the display module 107. On the other hand, in the normal use other than the case of reproducing moving image content, a screen subjected to gamma conversion using the normal use gamma table 43 is displayed on the display module 107.

As described above, according to the embodiment, depending on whether the video player 321 is reproducing moving image content, the gamma table to be used in gamma conversion is switched between the moving-image-reproduction gamma table 42 and the normal use gamma table 43. Hence, the image quality of the images displayed on the display module 107 changes automatically depending on whether the moving image content is being reproduced. This enables achieving enhancement in the user-friendliness of the notebook PC 100.

While, for example, in the embodiment described above, the CPU 11 and the GPU 15 are installed as independent components, the CPU 11 may be configured to have the functions of the GPU 15. In such a configuration, the CPU 11 may be configured to have the functions of the MCH 12 as well. Moreover, depending on the configuration of the notebook PC 100, the ICH 14 can be replaced with a platform controller hub (PCH).

Further, in the embodiment described above, each of the OS 31, the image quality adjusting module 33, and the display driver 34 are written as independent computer programs. Alternatively, the OS 31 can be written to perform the functions of the image quality adjusting module 33 and the display driver 34.

Still further, in the embodiment described above, brightness values at the time of generating display signals are adjusted according to the illuminance of the environment light around the notebook PC 100. However, the brightness values may be set to be constant. In this case, the illuminance sensor 108 and the brightness conversion table 41 may be omitted from the configuration illustrated in FIG. 2. Besides, the averaging module 211, the brightness changing module 331, and the brightness setting module 341 may be omitted from the configuration illustrated in FIG. 5.

Still further, in the embodiment described above, depending on whether moving image content is being reproduced, the condition for gamma conversion performed on display signals is changed to adjust the image quality during the image processing. However, apart from this, the condition for sharpness, smoothing, resolution, or the like may also be changed during the image processing depending on whether moving image content is being reproduced.

Furthermore, in the embodiment described above, the process of the video player 321 is considered to be the unit of processing. However, alternatively, the thread of the video player 321 can also be considered as the unit of processing.

Meanwhile, the computer program executed on the notebook PC 100 of the embodiment is provided as being stored in advance in a storage medium (the BIOS-ROM 16 or the memory 17). The computer program may also be provided as being stored in a computer-readable storage medium, such as a compact disc-read only memory (CD-ROM), a flexible disk (FD), a compact disc recordable (CD-R), and a digital versatile disc (DVD), as a file in an installable or executable format. Further, the storage medium is not confined to a medium that works independent of a computer or an embedded system, but can also be a storage medium in which the computer program communicated via a local area network (LAN) or the Internet are downloaded and stored permanently or temporarily.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor comprising:
a moving image reproducing module configured to reproduce moving image content;
a display module configured to display a screen of the moving image content reproduced by the moving image reproducing module; and
an image quality adjusting module configured to adjust image quality of the screen, which is displayed by the display module, depending on whether the moving image reproducing module is reproducing the moving image content.

2. The information processor of claim 1, wherein the moving image reproducing module includes one or more moving image reproducing modules,
the information processor further comprising a status managing module configured to individually manage an operating status of each of the one or more moving image reproducing modules, the operating status indicating whether the moving image reproducing module is reproducing the moving image content, wherein
based on the operating status of each of the moving image reproducing modules managed by the status managing module, the image quality adjusting module is configured to determine whether each of the moving image reproducing modules is reproducing the moving image content.

3. The information processor of claim 2, wherein, if at least one operating status from among operating statuses managed by the status managing module indicates that the moving image content is being reproduced, the image quality adjusting module changes image quality of an image displayed by the display module to image quality set in advance for reproducing the moving image content.

4. The information processor of claim 2, wherein
the display module is configured to display a basic operation screen related to operation of the information processor, and
if all operating statuses managed by the status managing module indicate that the moving image content is not being reproduced, the image quality adjusting module changes image quality of an image displayed by the display module to image quality set in advance for displaying the basic operation screen.

5. The information processor of claim 2, wherein
the moving image reproducing module represents the a unit of processing run by execution of a predetermined computer program, and
the status managing module is configured to check the unit of processing of each of the moving image reproducing modules for which the operating status is to be managed and, if the unit of processing of a moving image reproducing module does not exist or is not responding, to exclude the moving image reproducing module from the moving image reproducing modules for which the operating status is to be managed.

6. The information processor of claim 2, wherein
the status managing module is configured to manage the operating status of each of the moving image reproducing modules based on binary flag information, and
the image quality adjusting module is configured to determine whether the moving image reproducing modules are reproducing the moving image content based on a calculation result of a logical sum of the flag information.

7. The information processor of claim 1, further comprising an illuminance value detecting module configured to detect an illuminance value of environment light around the information processor, wherein
the image quality adjusting module is configured to generate an image, for which the image quality is to be adjusted, based on a brightness value corresponding to the illuminance value detected by the illuminance value detecting module.

8. An information processing method comprising:
reproducing, by a moving image reproducing module, moving image content;
displaying, by a display module, a screen of the moving image content reproduced at the reproducing; and
adjusting, by an image quality adjusting module, image quality of the screen, which is displayed at the displaying, depending on whether the moving image content is being reproduced at the reproducing.

9. A computer program product embodied on a non-transitory computer-readable storage medium and comprising code that, when executed, causes a computer to:
reproduce moving image content;
display a screen of the moving image content being reproduced; and
adjust the image quality of the screen being displayed depending on whether the moving image content is being reproduced.
